(19) United States
(12) Patent Application Publication
(10) Pub. No.: US 2005/0255238 A1
(43) Pub. Date: Nov. 17, 2005

(54) Pulsed heating process for curing substrates with near infrared radiation

(76) Inventors: Charles N. Myer, Houston, TX (US); Owen H. Decker, Houston, TX (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/844,758

(22) Filed: May 12, 2004

(51) Int. Cl. B05D 3/10

(52) U.S. Cl. 427/189; 427/553

(57) ABSTRACT

The present invention is directed to a process for coating a surface of a substrate with a powder coating composition and forming a smooth film thereon; wherein the process comprises: applying a powder coating composition to a surface of a substrate; melting and curing the powder coating composition, wherein pulsed NIR radiation is used to perform said melting and curing of the powder coating composition, the NIR radiation being provided by an NIR radiation emitter and the pulsed NIR radiation comprising the steps of: a) applying heat by NIR radiation at 20-50% NIR radiation emitter power to the surface of the substrate coated with the powder coating composition for a sufficient time to at least partially adhere the powder coating to the surface of the substrate; and then b) removing the heat for a period of time to allow the powder coating to at least partially coalesce and adhere to the surface of the substrate; and then c) applying said heat by NIR radiation at 80-100% NIR radiation emitter power to the surface of the substrate to form a smooth cured film thereon.

The present invention is directed to a pulsed heating process that utilizes near infrared radiation (NIR) to cure powder coatings. In particular, this invention is directed to producing smoother coatings having an improved appearance with the same amount of energy and heating time as used in conventional NIR cure processes. The process of this invention can also be used to cure powder coatings typically cured via infrared radiation (IR).

### BACKGROUND OF THE INVENTION

Powder coatings have been widely used in metal coating processes to provide decorative or functional finishes to substrates. Such widespread use is largely due to the increased economic viability of the powder coating process itself, as well as, the favorable influence of the coating process on the environment. Numerous powder coating formulations and processes have been developed for a variety of different applications.

The processes developed thus far for curing powder coatings, however, have required that the powder coating deposited on the substrate first be melted by being heated to a temperature above the glass transition temperature or melting point of the powder coating formulation. The conventional heat sources that have typically been used to heat the powder coating formulations have included, for example, convection ovens, infra-red light sources, or combinations of the two.

The melted powder coatings are then cured. In the case of thermal crosslinking systems, the powder coating is typically cured by being heated to a temperature of between 140 and 200° C. for a period of approximately 10 to 30 minutes. In the case of UV-curable powder coatings, the melted powder coating is cured within a few seconds via ultraviolet radiation. The powder coatings are generally cross-linked by polymerizing double bonds or cyclic ethers using a free radical or cationic reaction mechanism.

Both of these processes, however, have several disadvantages. First, elevated temperatures are necessary to thermally cure powder coatings which, on the one hand, does not allow temperature-sensitive surfaces, such as wood or plastic to be coated and, on the other hand, requires an elevated energy input for metal components. Secondly, using UV-cured powder coatings entails two process steps as the powder must first be melted by being heated, and then be cured in a second step by UV radiation. Finally, curing thick films of pigmented powder coatings with UV Radiation is problematic because the UV radiation is absorbed by the coloring components so that achieving a complete cure of the coating is more difficult.

More recently a method was developed wherein powder coatings are cured by using high intensity radiation in the near infrared (NIR) range. The article “Sekundenschnelle Aushartung von Pulverlack” (“Curing Powder Lacquer in Seconds”) (Kai Bar, JOT 2/98) describes a process wherein powder coatings are cured with the aid of NIR radiation without causing the substrate coated with the powder coating to be heated to any substantial degree. As a result, the NIR radiation method enables powder coatings to be melted and cured in a single process step without the disadvantages associated with conventional thermal curing and/or UV curing processes as described hereinabove.

“NIR radiation” as used herein, means wavelengths of high intensity radiation in the ranges from 760-1500 nm.

There are, however, several disadvantages associated with this NIR curing process. First, the length of heating time required to obtain a coating that exhibits a level of smoothness that is acceptable can be excessive when the coated substrate is heated in a continuous manner. Second, the conventional NIR curing processes rapidly heat the powder coating at the maximum rate of 100% power of the NIR radiation emitter to melt and cure the powder coating. The rapid level of heating causes the finish to exhibit excessive orange peel and/or burning thereby producing a finish having a level of smoothness that is unacceptable. In sum, conventional NIR radiation curing methods may detrimentally affect the smoothness and appearance of a powder coating finish.

In order to address the disadvantages of conventional NIR radiation curing methods, the pulsed heating process of the present invention has been developed. More specifically, the present invention is directed to a pulsed heating process wherein NIR radiation is used to heat and cure a powder coating so as to produce a finish having exceptional smoothness and excellent appearance with the use of only a minimal amount of time, heat and energy.

### SUMMARY OF THE INVENTION

The present invention is directed to a process for coating a surface of a substrate with a powder coating composition and forming a smooth film thereon; wherein the process comprises:

applying a powder coating composition to a surface of a substrate;

melting and curing the powder coating composition, wherein pulsed NIR radiation is used to perform said melting and curing of the powder coating composition, the NIR radiation being provided by an NIR radiation emitter and the pulsed NIR radiation comprising the steps of:
a) applying heat by NIR radiation at 20-50% NIR radiation emitter power to the surface of the substrate coated with the powder coating composition for a sufficient time to at least partially adhere the powder coating to the surface of the substrate; and then
b) removing the heat for a period of time to allow the powder coating to at least partially coalesce and adhere to the surface of the substrate; and then
c) applying said heat by NIR radiation at 80-100% NIR radiation emitter power to the surface of the substrate to form a smooth cured film thereon.

### BRIEF DESCRIPTION OF THE DRAWINGS

FIG. 1 is a graph that shows temperature of a substrate coated with a powder coating and % emitter power vs. exposure time in seconds.

### DETAILED DESCRIPTION OF THE INVENTION

The features and advantages of the present invention will be more readily understood, by those of ordinary skill in the art, from reading the following detailed description. It is to be appreciated those certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both preceded by the word “about.” In this manner, slight variations above and below the stated ranges can be used to achieve substantially the same results as values within the ranges. Also, the disclosure of these ranges is intended as a continuous range including every value between the minimum and maximum values.

All patents, patent applications and publications referred to herein are incorporated by reference.

The novel process of this invention coats the surface of a substrate with a powder coating composition and forms a smooth cured film thereon. The process comprises the following:

a powder coating composition is applied to a surface of a substrate;

the powder coating composition is melted and cured to form a film on the substrate. Pulsed NIR radiation is used to perform the melting and curing of the powder coating composition. The NIR radiation is provided by an NIR radiation emitter and the pulsed NIR radiation is applied to the substrate as follows:
a) NIR radiation at 20-50% NIR radiation emitter power, preferably for 2.5 seconds at 35% NIR radiation emitter power, is applied to the surface of the substrate coated with the powder coating composition for a sufficient time to at least partially adhere the powder coating to the substrate; and then
b) the NIR radiation is terminated for a period of time to allow the powder coating to at least partially coalesce and adhere to the surface of the substrate, preferably for 0.5-5 seconds and more preferably from 1-3 seconds; and then
c) the NIR radiation is applied to the surface of the substrate at 80-100% NIR radiation emitter power, preferably for at least 2.5 seconds at 100% NIR radiation emitter power, to melt and cure the powder coating composition to form a smooth film thereon. Preferably, the substrate's final temperature reaches 245-265° C.

The NIR radiation used according to the invention is infrared radiation in the wavelength range of from about 760 to about 1500 nm, preferably 760 to 1200 nm. Radiation sources for NIR radiation include, for example, NIR radiation emitters that are able to emit radiation as a flat, linear or point source. NIR radiation emitters of this kind are available commercially (for example, from Adphos). These include, for example, high performance halogen radiation emitters with an intensity (radiation output per unit area) of generally more than 10 kW/m² to, for example, 15 MW/m², preferably from 100 kW/m² to 1000 kW/m². For example, the radiation emitters reach a radiation emitter surface temperature (coil filament temperature) of more than 2000° K., preferably, more than 2900° K., e.g. a temperature from 2000 to 3500° K. Suitable radiation emitters have, for example, an emission spectrum with a maximum between 760 and 1200 nm.

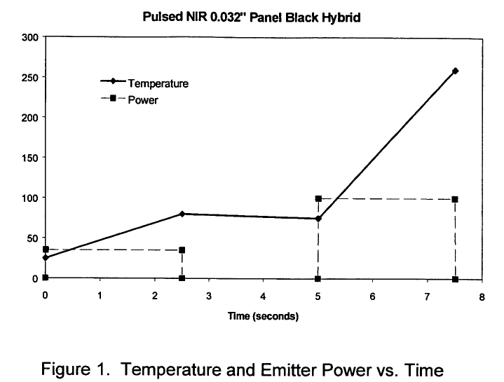

FIG. 1 is a typical graph that illustrates the results of the process of this invention and shows the temperature increase of a substrate coated with a powder coating and % emitter power vs. exposure time in seconds. FIG. 1 shows an increase in surface temperature of a powder coated panel to about 75° C. when the emitter power was held at 35% of its total power for 2.5 seconds. Emitter power was turned off for 2.5 seconds and surface temperature only dropped slightly. Then the emitter power was increased to 100% and the panel was exposed for an additional 2.5 seconds with a rapid temperature increase to about 255° C.

The powder coating composition used in the process of this invention contains 40 to 90 wt. %, preferably 60 to 90 wt. %, of at least one film forming NIR radiation curable resin, such as an epoxy resin, a polyester resin, (meth)acrylic resin, epoxy polyester resin, or a silicone resin; 2 to 50 wt. % of a curing agent; 1 to 50 wt. %, preferably 1 to 40 wt. %, of pigments and/or fillers; 0.1 to 3 wt. % of crosslinking catalysts; and optionally, further auxiliary substances and additives. All of the above wt. % are based on the total weight of the powder coating composition.

The above NIR radiation curable resins contain epoxy resins, polyester resins, (meth)acrylic resins, epoxy polyester resins or silicone resins containing epoxy, OH, COOH, RNH, NH₂ and/or SOH as the functional groups that form bonds.

The term “(meth)acrylic” denotes “acrylic” and/or “(meth)acrylic”.

One particularly useful resin comprises an epoxy resin of epichlorohydrin and bisphenol A having an epoxide equivalent weight of 200 to 2500. Another useful resin comprises at least 50 wt. % of a polyester type resin. Suitable crosslinking resins that can be used include, but are not limited to, di- and/or polyfunctional carboxylic acids, dicyandiamide, phenolic resins, amino resins and/or isocyanates.

The powder coating compositions used in the process of this invention contain conventional binder curing agents, such as, low molecular weight polyester resins, epoxy and/or hydroxy alkyl amide curing agents, and/or dimerized isocyanates, dicyandiamide curing agents, carboxylic acid curing agents or phenolic curing agents, or also epoxy-functionalized acrylate resins with carboxylic acid or carboxylic anhydride curing agents. Typical examples of such curing agents include: di- and/or polyfunctional carboxylic acids; dicyandiamide; phenolic resins; amino resins; triglycidyl isocyanurate (TGIC); polyglycidyl esters based on terephthalic acid/trimellitic acid, which are available from Ciba Spezialitaten Chemie under the tradename ARALDITE® PT 910; polyfunctional aliphatic oxirane compounds, such as are provided, for example, by DSM Resins under the tradename URANOX®; and glycidyl-functionalized (meth)acrylate copolymers.

Examples of curing agents for epoxy resins are curing agents containing carboxyl groups, those containing amide and/or amine groups, for example, dicyandiamide and the derivatives thereof, carboxylic acids as well as phenolic resins.

The powder coating composition used in the process of this invention contains 1 to 50 wt. % of pigment to provide color to the composition. The pigment may be conventional organic or inorganic pigments including carbon black or dyes, as well as, metallic and/or non-metallic special effect imparting agents.

Polyester resins used in the powder coating used in the process of this invention may be produced in a conventional manner by reacting polycarboxylic acids, and the anhydrides and/or esters thereof with polyalcohols, as is, for example, described in D. A. Bates, The Science of Powder Coatings, volumes 1 & 2, Gardiner House, London, 1990.

Mixtures of carboxyl and hydroxyl group containing polyesters may be used. The carboxy-functionalized polyesters according to the invention conventionally have an acid value of 10 to 200 mg of KOH/g of resin and the hydroxy-functionalized polyesters have an OH value of 10 to 200 mg of KOH/g of resin.

The curing agents that may be used when polyester resins are used to formulate the powder coating composition include, but are not limited to, conventional curing agents, such as, for example, cycloaliphatic, aliphatic or aromatic polyisocyanates; cross-linking agents containing epoxy groups, such as, for example, triglycidyl isocyanurate (TGIC); polyglycidyl ethers based on diethylene glycol; glycidyl-functionalized (meth)acrylic copolymers; and cross-linking agents containing amino, amido, or hydroxyl groups.

The curing agents that may be used when carboxy-functionalized polyester resins are used to formulate the powder coating composition include, but are not limited to, polyfunctional epoxides and polyfunctional hydroxyalkylamides. The curing agents that may be used when hydroxy-functionalized polyester resins are used include, but are not limited to, polyfunctional isocyanates that may, for example, be reversibly blocked by forming uretdione groups.

The (meth)acrylate resins used in the powder coating used in the process of this invention may, for example, be produced from alkyl (meth)acrylates with hydroxyalkyl (meth)acrylate and olefinic monomers, such as, for example, styrene and/or styrene derivatives. The (meth)acrylate resins may also comprise modified vinyl copolymers, for example, based on monomers containing glycidyl groups and one or more ethylenically unsaturated monomers, such as, for example, alkyl (meth)acrylate, styrene, and styrene derivatives.

The curing agents that may be used when (meth)acrylate resins are used to formulate the powder coating composition include, but are not limited to, solid dicarboxylic acids that have, for example, 10 to 12 carbon atoms; and carboxy-functional polymers.

Functionalized epoxy/polyester hybrid systems may also be used to formulate the powder coating compositions used in the process of the present invention. For example, systems having an epoxy/polyester ratio of 50:50 or 30:70 may be used. In such hybrid systems, however, the functional groups, such as, for example, carboxyl groups, are generally present in the polyester component.

The powder coating formulations of the present invention may further comprise additives conventionally used in powder coating technology including, but not limited to, flow control agents, accelerators, degassing agents, flatting agents, texturing agents, dispersants, thixotropic agents, adhesion promoters, antioxidants, light stabilizers, curing catalysts, anticorrosion agents and mixtures thereof. These are added in amounts that are familiar to a person of ordinary skill in the art. For example, the powder coating composition may contain 0.01 to 10 wt. % additives.

Curing catalysts, such as, for example, tin salts, phosphides, amines and amides, may be added to the powder coating formulation to accelerate the cross-linking reaction. Such curing catalysts may be used in quantities of, for example, 0.1 to 3 wt. %, based on total weight of the coating composition.

The process of the present invention is suitable for curing both clear powder coatings and colored powder coatings colored by means of pigments and fillers. A person of ordinary skill in the art is familiar with the type and quantity of pigments and fillers that are suitable for producing a colored powder coating.

The powder coating compositions used in the process of the present invention may be produced using conventional extrusion/grinding processes, which are well-known to a person of ordinary skill in the art. However, other processes may also be used, such as, for example, either spraying the powder coating composition from a supercritical solution, or using a “nonaqueous dispersion” process to produce the powder coating composition, both of which are processes well known to a person of ordinary skill in the art.

The powder coating compositions of the present invention may be readily applied to the substrate to be coated using application methods known in the powder coating art. Typically, the powder coating is applied by standard means, such as fluidized bed immersion, electrostatic spray application, flocking, tribostatic spray application, and the like. It is also possible to apply the powder in the form of an aqueous dispersion or “powder slurry”. The NIR radiation may then advantageously be used to remove the water.

### EXAMPLES

The present invention is further defined in the following Examples. It should be understood that these Examples are given by way of illustration only. From the above discussion and this Example, one skilled in the art can ascertain the essential characteristics of this invention, and without departing from the spirit and scope thereof, can make various changes and modifications of the invention to adapt it to various uses and conditions. As a result, the present invention is not limited by the illustrative examples set forth herein below, but rather is defined by the claims contained herein below.

Preparing, Applying, Melting and Curing the Powder Coatings

The powder coating composition used in the example and in the comparative examples was converted into a powder coating via a conventional technique used to form powder coating compositions. That is, the constituents of each coating formulation were intensively mixed in a ZSK twin-screw extruder operated at 300 rpm and wherein each zone was at 60° C. The extrudate was ground in a Bantam grinder and sieved using an 80-mesh screen. The resulting powder coating composition had a particle size ranging from 2 μm to 250 μm, with an average particle size of 75 μm. The powder coatings were then applied electrostatically with a Corona powder spray gun in identical film thickness to Q Panels (0.032″×3″×5″ steel panels). The panels were then exposed to NIR radiation (760 nm to 1200 nm) using NIR super burn emitters. The NIR emitters are tungsten-filament lamps, 25 cm in length, ranging from 250W (“Low Burn”) to 2000W (“Super Burn”). The lamps are arranged in an array, which was raised 75 mm above the steel panels for this test. The NIR emitters and equipment are supplied by Adphos Inc., of Germany.

Test Procedures

Gloss Measurement

The following gloss measurement test procedure was used in generating the data reported in Table 2:

20° gloss measurement—gloss was measured at 20° using a Byk Gardner Micro-tri-gloss portable measuring unit. A rating of at least 60 units is an acceptable minimum to be considered “smooth” and of “high gloss”.

60° gloss measurement—gloss was measured at 60° using a Byk Gardner Micro-tri-gloss portable measuring unit. A rating of at least 85 units is an acceptable minimum to be considered “smooth” and of “high gloss”.

Each gloss number contained in Table 2 is an average of three measurements on the same Q panel.

Powder Coating Formulation

Table 1 shows the formulation of the black hybrid powder coating used in Example 1 and Comparative Examples 1, 2 and 3.

TABLE 1
Black Hybrid Powder Coating Formulation

| Ingredient | PHR* |
|---|---|
| Epon ® Resin 2002 (Resolution | 50 |
| Performance Products, LLC)¹ | |
| Crylcoat ® 340 (UCB)² | 50 |
| Modaflow ® 6000 (Solutia, | 1.3 |
| Inc.)³ | |
| Oxymelt A4 (Estron)⁴ | 1.0 |
| Castorwax (Caschem)⁵ | 1.0 |
| Raven ® 450 (Columbian | 1.2 |
| Chemicals)⁶ | |
| Blanc Fixe (Solvay)⁷ | 25.0 |
| HDKN20 Silica (Wacker)⁸ | 0.2 |

*PHR is defined as the number of parts of a component for every hundred parts of resin in the formula.
¹Epon ® 2002 is a bisphenol-A based resin with glycidyl functional groups, with an epoxide equivalent weight of 675-760 eq./g manufactured by Resolution Performance Products, LLC, Houston, TX.
²Crylcoat ® 340 is a carboxy-functional polyester-based resin with an acid value of 71 manufactured by UCB Chemical Corp., Smyrna, GA.
³Modaflow ® 6000 is a flow-enhancing additive manufactured by Solutia, Springfield, MA.
⁴Oxymelt A4 is an additive designed to promote degassing of the film, manufactured by Estron Chemical Inc, Calvert City, KY.
⁵Castorwax ® is a hydrogenated castor oil derivative manufactured by Caschem Inc., Bayonne, NJ.
⁶Raven ® 450 is a carbon black pigment produced by Columbian Chemicals Company, Marietta, GA.
⁷Blanc Fixe is a barium sulfate product produced by Solvay S.A., Brussels, Belgium.
⁸HDKN20 Silica is a silica material manufactured by Wacker Chemie, Berghausen, Germany.

### EXAMPLE 1

The black hybrid powder coating was applied to a Q-panel at room temperature. After being applied, the powder coating was melted and cured by being heated for 2.5 seconds at an NIR emitter power of 35%, followed by a pause in the heat of 0.1 seconds, and then followed by another 2.5 seconds of heat at an NIR emitter power of 100%. A panel was prepared wherein there was no pause in the heat and heating went directly from 35% emitter power to 100% emitter power. A set of five additional Q panels were prepared with the black hybrid powder coating in which the coating was applied to each of the five Q panels at room temperature, wherein each panel was subjected to the same pulsed 2.5 second, pause, 2.5 second curing process set forth hereinabove with the only difference being that each coated panel was subjected to a pause having a different length of time. That is, after the five additional Q-panels were coated, the powder coating of each Q panel was melted and cured by being heated for 2.5 seconds at an NIR emitter power of 35%, followed by a pause in the heat of 0.5, 1.0, 1.5, 2.5, or 5.0 seconds, and then followed by another 2.5 seconds of heat at an NIR emitter power of 100%. The final temperature of all of the Q-panels subjected to this pulsed curing process ranged from 245-275° C. The gloss at 20° and 60° was measured for each of the above panels and the results are shown on Table 2.

Table 2 shows that panel having 0 and 0.1 second pause time gave unacceptable 20° and 60° gloss measurements. Panels having 0.5 to 5 second pause time gave acceptable 20° and 60° gloss measurements.

### Comparative Example 1

The black hybrid powder coating was applied to a Q-panel at room temperature. The powder coating was then melted and cured by being slowly heated at a NIR emitter power of 35% for 18 seconds to enable the powder to melt and flow out before the onset of cure. The panel surface temperature was 260° and a finish having acceptable smoothness was obtained. The gloss at 20° and 60° was measured for each of the above panels and the results are shown in Table 2. Acceptable results being defined as a finish that completely covers the surface of the Q panel without having any holes or burned spots.

This slow heating process, however, required substantially more melting and curing time than conventional NIR radiation curing methods, which are recognized as being advantageous due to their short curing times. Accordingly, although the finish obtained in accordance with this slow heating process exhibited the desired level of smoothness, shorter, not longer, melting and curing times are desired.

### Comparative Example 2

The black hybrid powder coating was applied to a Q panel at room temperature. The powder coating was then melted and cured by being heated at the maximum NIR emitter power of 100% for 4 seconds. The finish obtained was unacceptable as the powder exhibited poor flow, the finish did not entirely cover the Q panel, and the finish at the edge of the panel was burned. No attempt was made to measure the gloss at 20° and 60° since the finish was not considered acceptable.

### Comparative Example 3

The black hybrid powder coating was applied to a Q panel at room temperature. The powder coating was then melted and cured via a ramped two-step heating process wherein the powder coating was first subjected to a low NIR emitter power of 35% for a period of 3.5 seconds so as to slowly bring the temperature of the powder coating up to or near its melting point. It was experimentally determined that the minimum amount of time to which the powder coating could be exposed to a low NIR emitter power of 35% and still achieve acceptable results was 3.5 seconds. Acceptable results being defined as a finish that completely covers the surface of the Q panel without having any holes or burned spots.

Upon reaching or nearing the melting point, the powder coating was rapidly heated at a maximum NIR emitter power of 100% for 2.25 seconds. The Q panel reached a peak temperature of 251° C.

Although this process decreased the heating time of Comparative Example 1 from 18 seconds to 5.75 seconds, this process was still inefficient because the period of time at which the emitters were run at low NIR emitter power prevented the NIR emitters from realizing their full potential in terms of heating rate. The efficiency of the cure process being defined in terms of actual heating time, and not the time it took to reach full cure. As a result, although the ramped two-step heating process minimized the total amount of heating time needed, problems with efficiency, flow, and smoothness remained.

Table 2 illustrates the smoothness of each of the Example 1, as well as, Comparative Example 1 and 3 finishes via gloss measurements at 20° and 60°.

TABLE 2

| | Pause | | |
|---|---|---|---|
| | (sec) | Gloss 20° | Gloss 60° |
| Example 1 | 0.0 | 18.5 | 63.1 |
| | 0.1 | 21.9 | 69.5 |
| | 0.5 | 47.6 | 85.6 |
| | 1.0 | 50.4 | 91.0 |
| | 1.5 | 64.1 | 94.1 |
| | 2.5 | 67.7 | 89.5 |
| | 5.0 | 65.6 | 87.8 |
| Comparative | — | 73.9 | 92.6 |
| Example 1 | | | |
| Comparative | — | Failed | Failed |
| Example 2 | | | |
| Comparative | — | 59.8 | 89.7 |
| Example 3 | | | |

Although Table 2 indicates that the finishes obtained with the Example 1 pulse curing process were in general not as smooth as the finishes obtained with the Comparative Example 1 panels that were cured at 35% power for 18 seconds, the Example 1 pulsed curing process advantageously allows a finish to be obtained that still has acceptable smoothness in less heating time than is required by the Comparative Example 1 finishes. In addition, Table 2 indicates that the Example 1 pulsed curing process advantageously produces a finish having better smoothness than Comparative Example 3 in a comparable amount of curing time and less heating time.

1. A process for coating a surface of a substrate with a powder coating composition and forming a smooth film thereon; wherein the process comprises:
applying a powder coating composition to a surface of a substrate;
melting and curing the powder coating composition, wherein pulsed NIR radiation is used to perform said melting and curing of the powder coating composition, the NIR radiation being provided by an NIR radiation emitter and the pulsed NIR radiation comprising the steps of:
a) applying heat by NIR radiation at 20-50% NIR radiation emitter power to the surface of the substrate coated with the powder coating composition for a sufficient time to at least partially adhere the powder coating to the surface of the substrate;
b) removing the heat for a period of time to allow the powder coating to at least partially coalesce and adhere to the surface of the substrate; and
c) applying said heat by NIR radiation at 80-100% NIR radiation emitter power to the surface of the substrate to form a smooth cured film thereon.

2. The process according to claim 1 wherein said pulsed NIR radiation is applied comprising the steps of:
a) applying heat to the surface of the substrate for 2.5 seconds at 35% NIR emitter power;
b) removing the heat for a period of time ranging from 0.5 to 5.0 seconds; and then
c) applying said heat to the surface of the substrate for 2.5 seconds at 100% NIR emitter power;
wherein said substrate reaches a final temperature ranging from 245-275° C.

3. The process according to claim 2, wherein said heat is applied for a period of time ranging from 1.5 to 20 seconds.

4. The process according to claim 1, where the NIR radiation has a radiation output per unit of 10 kw/m² to 15 MW/m².

5. The process according to claim 1, wherein said heat is removed for a period of time ranging from 1.5 to 5.0 seconds.

6. The process according to claim 1 wherein the powder coating composition comprises NIR radiation curable resin from the group of epoxy resins, polyester resins, (meth)acrylic resins, epoxy polyester resins, or silicone resins.

7. The process according to claim 6 wherein the NIR radiation curable resin comprises an epoxy resin.

8. The process according to claim 7 wherein the epoxy resin comprises epichlorohydrin and bis phenol A having an epoxide equivalent weight of 175 to 2500.

9. A substrate coated according to the process of claim 1.
